(19) United States
(12) Patent Application Publication
(10) Pub. No.: US 2010/0018170 A1
(43) Pub. Date: Jan. 28, 2010

(54) FILL SUPPLY MECHANISM FOR SOFT CAPSULE MACHINE

(75) Inventor: Adrian Oana, Windsor (CA)

Correspondence Address: HARNESS, DICKEY & PIERCE, P.L.C., P.O. BOX 828, BLOOMFIELD HILLS, MI, 48303, US

(73) Assignee: TECHNOPHAR EQUIPMENT AND SERVICE (2007) LTD., Tecumseh (CA)

(21) Appl. No.: 12/178,340

(22) Filed: Jul. 23, 2008

(51) Int. Cl. B65B 47/00; B67D 5/46

(52) U.S. Cl. 53/560; 222/372; 222/380; 222/383.1; 53/563; 53/575

(57) ABSTRACT

A fill supply mechanism can include a pumping member that moves reciprocally within a pump cavity thereby causing fill material to be drawn into and expelled from the pump cavity. A valve member can be reciprocally movable and can allow fill material to be drawn into the pump cavity when in a first valve member position and allow fill material to be discharged from the pump cavity when in a second valve member position. A drive mechanism drives reciprocal motion of the pumping member and the valve member. The reciprocal motion of the pumping member and the valve member are along co-planar axes and can be along parallel co-planar axes.

### BACKGROUND AND SUMMARY

The present disclosure relates to encapsulation machines and, more particularly, to a fill supply mechanism for a soft encapsulation machine.

Typical soft encapsulation machines form at least two flexible gelatin sheets or ribbons by cooling molten gelatin on separate drums, then lubricating and guiding the sheets into communication with each other over co-acting dies while simultaneously dispensing a desired quantity of fill material between the sheets in sync with cavities in the outer surfaces of the dies to produce soft capsules. A fill supply mechanism is utilized to dispense a desired quantity of fill material. The fill supply mechanism can utilize mechanical gears and cams to provide reciprocating motion to pumps that dispense desired quantities of the fill material. The pumps can be positive displacement piston pumps that draw fill material therein during movement between two positions in a first direction and push the fill material out during movement between the two positions in the other direction. Typically, a valving member is used to change the flow paths that communicate with the pump chamber. The valve is coordinated to have the appropriate passages communicating with one another to allow the pump to draw the fill material in and discharge the fill material out during movement. The valving member can also undergo reciprocal motion. The reciprocating motion of the valve member is typically 90° offset from the reciprocating motion of the pump.

The driving of the pump and the valve member along different 90° offset axes can require two separate drive mechanisms to provide the associated motions. Alternatively, a complex transmission mechanism that can provide both motions with a single drive can be utilized. The use of two different drive mechanisms can increase the cost and size of the fill supply mechanism. Additionally, the use of a single drive mechanism that provides the two differing motions can be complicated and also expensive due to the complicated transmission needs to drive reciprocation motion along two axes that are 90° offset. The complicated transmission can also be susceptible to failure and/or excessive maintenance requirements.

Thus, it would be advantageous to have a fill supply mechanism that can be of a simple construction. Furthermore, it would be advantageous if such construction were compact, utilized less parts, were more robust, provided greater durability, and/or were less expensive to produce. Furthermore, it would be advantageous if such a fill supply mechanism were able to utilize a pump and valve member that reciprocated along co-planar axes. Additionally, it would be advantageous if the fill supply mechanism were able to be precisely controlled, thereby facilitating precise control of the operation of the fill supply mechanism relative to the encapsulation machine.

A fill supply mechanism according to the present disclosure can utilize a single driveshaft to impart reciprocating motion to the pumps and the valve members. The fill supply mechanism can include a pump housing with a pump cavity and a pumping member that moves reciprocally within the pump cavity between first and second pumping member positions, thereby causing fill material to be drawn into and expelled from the pump cavity. A valve member can be reciprocally movable between first and second valve member positions and can allow fill material to be drawn into the pump cavity when in the first valve member position and allow fill material to be discharged from the pump cavity when in the second valve member position. A drive mechanism drives reciprocal motion of the pumping member and the valve member. The reciprocal motion of the pumping member and the reciprocal motion of the valve member are along co-planar axes. The reciprocal motion of the pumping member and the valve member can be along parallel co-planar axes. The distance between the first and second pumping member positions can be variable and can be precisely controlled to provide a desired quantity of fill material.

A soft-gel encapsulation machine can include a fill-supply mechanism along with a pair of dies having cavities thereon which are operable to form capsules therebetween. A wedge assembly can receive fill material from the fill supply mechanism and can insert the fill material into the cavities in the dies such that capsules formed between the dies contain the fill material.

A method of forming soft-gel capsules can include pumping a fill material to a wedge assembly by driving reciprocal motion of a pumping member between first and second pumping member positions and driving reciprocal motion of a valve member between first and second valve member positions. The reciprocal motions of the pumping member and the valve member can be along co-planar axes. Two sheets of capsule-forming material can be supplied to the wedge assembly, and the wedge assembly can heat the sheets and insert the fill material between the sheets. The capsules containing the fill material can be formed with a pair of co-acting dies having cavities formed thereon.

Thus, a fill supply mechanism according to the present disclosure can advantageously be of a simple construction, compact, utilize less parts while being more robust, provide greater durability, and/or reduce costs. The fill supply mechanism can advantageously utilize a pump and a valve member that reciprocate along co-planar axes. Additionally, the fill supply mechanism can be precisely controlled to provide a desired quantity of fill material during the encapsulation process.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic representation of an encapsulation machine according to the present disclosure;

FIGS. 2 and 3 are perspective views of the fill supply mechanism according to the present disclosure with the housing in place and partially fragmented, respectively;

FIGS. 4 and 5 are two different perspective views of the fill supply mechanism of FIG. 2 with the housing removed;

FIGS. 6A-D are cross-sectional views along line 6-6 of FIG. 4 showing various stages of operation of the fill supply mechanism;

FIG. 7 is a perspective view of the valve cam wheel of the fill supply mechanism;

FIG. 8 is a perspective view of the valve slide plate of fill supply mechanism; and

FIG. 9 is a perspective view of the pump drive carriage of the fill supply mechanism.

### DETAILED DESCRIPTION

The following description is merely exemplary in nature and is not intended to limit the present disclosure, application, or uses.

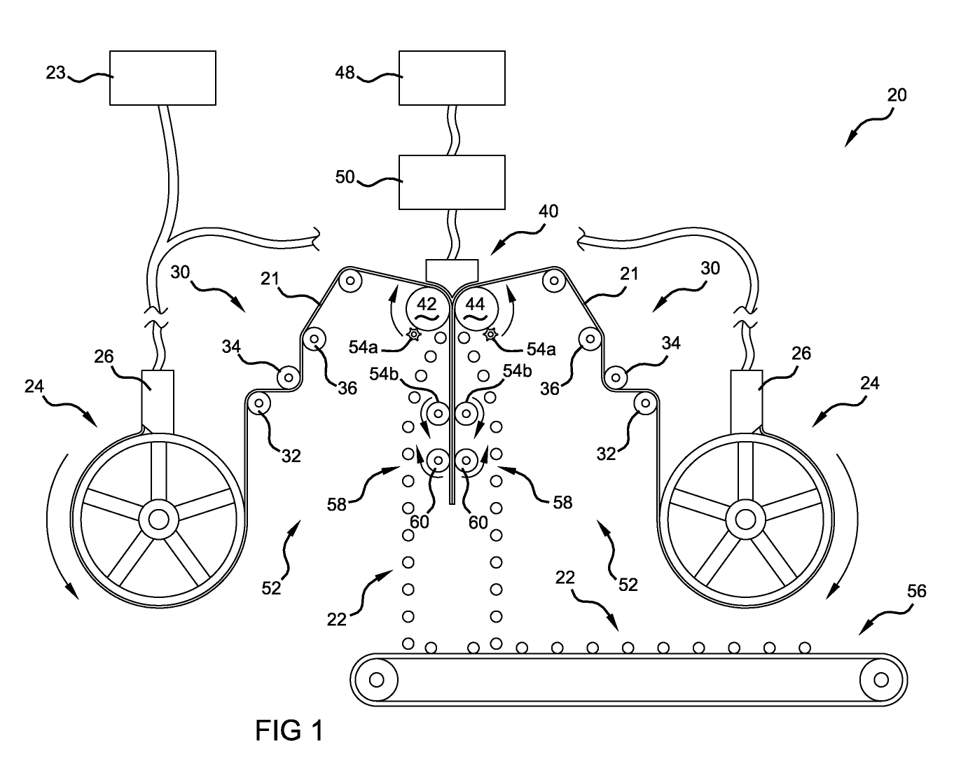

Referring to FIG. 1, a schematic representation of a soft gel encapsulation machine according to the present disclosure is shown. Encapsulation machine 20 is operable to produce soft gel capsules with a fill material therein. The fill material can be a liquid, suspensions, and the like by way of non-limiting example. The soft gel capsules produced by encapsulation machine 20 can be used for a variety of purposes. By way of non-limiting example, the fill material can be a medicine and the soft capsules used to administer the medicine, the fill material can be a paint or dye substance and the soft gel capsule is used in a paintball gun or similar type applications, the fill material can be an oil or ointment and soft gel capsules can be bath beads, and the like.

Encapsulation machine 20 produces two continuous flexible gelatin films/sheets/ribbons 21 on either side of the machine that are subsequently joined together with a fill material injected therebetween to form the soft gel capsules 22. The production of the two gelatin sheets 21 are substantially the same for both sides of encapsulation machine 20 and are essentially mirror images of one another. A gelatin tank 23 provides a gelatin in a molten state that is fed through hoses into spreader boxes 26 that are located above casting drums 24. Spreader boxes 26 spread molten gelatin on rotating casting drums 24. Casting drums 24 can be internally liquid cooled and externally air cooled. The cooling causes the molten gelatin that is spread on casting drums 24 to solidify and form flexible gelatin sheets 21. Each casting drum 24 produces a continuous flexible gelatin sheet that is used to form a portion of each capsule.

The gelatin sheets formed on casting drums 24 flow through oil roller assemblies 30. The oil roller assemblies include three rollers, 32, 34, 36. First roller 32 can be driven by a variable speed motor which is operated to cause first roller 32 to rotate at a desired rate. Second and third rollers 34, 36 can be mechanically linked to first roller 32 and, thus, their rate of rotation is also controlled by the rate rotation of first roller 32. One side of the gelatin sheet is in contact with second roller 34 while the opposite side of the gelatin sheet is in contact with third roller 36. Second and third rollers 34, 36 may each have a plurality of openings therein that allow an oil or lubricant to be applied to both sides of the gelatin sheet as it passes along the rollers. In some embodiments, second and third rollers 34, 36 may include porous material, such as polyethylene or felt by way of non-limiting example, which may dispense the oil or lubricant on both sides of the gelatin sheets as it passes along the rollers.

The two gelatin sheets flow into contact with a wedge assembly 40 and then through co-acting dies 42, 44. Wedge assembly 40 heats the sheets and supplies the fill material between the two gelatin sheets that is encapsulated within the soft gel capsules 22 produced by dies 42, 44. The fill material is supplied to wedge assembly 40 from a fill supply mechanism 50. A fill material hopper 48 supplies the fill material to fill supply mechanism 50, described in more detail below.

The two gelatin sheets travel between wedge assembly 40 and dies 42, 44, and fill material is injected between the sheets by wedge assembly 40. Dies 42, 44 rotate toward one another when producing soft gel capsules 22. Die 42 may be driven and die 44 may be mechanically linked to die 42 so that rotation of die 42 causes rotation of die 44. The mechanical link between dies 42 and 44 provides synchronization of the two dies relative to one another during operation. In some embodiments, dies 42, 44 may be individually driven with synchronized servomotors. Each die 42, 44 has a plurality of cavities thereon (not shown) that the gelatin sheets are pushed into by the fill material and cause the two sheets to be sealed together and cut along the cavities on the dies 42, 44 encapsulating the fill material therein and forming the soft gel capsules 22.

The soft gel capsules 22 produced between dies 42, 44 and the remaining gelatin sheets flow to a divider assembly 52. Divider assembly 52 includes a first pair of stripper rollers 54a that rotate at a relatively high speed very close to dies 42, 44 and a second pair of stripper rollers 54b that rotate at a relatively high speed in contact with the sheets to remove any soft gel capsules 22 that are clinging to dies 42, 44 and/or the gelatin sheets. The soft gel capsules 22 can fall onto one or more conveyors 56 that transport the soft gel capsules 22 to a dryer (not shown) or other processing equipment.

The gelatin sheets 21, after passing along the stripper rollers 54a, 54b flow into a mangle roller assembly 58 wherein a pair of mangle rollers 60 pulls on the gelatin sheets 21 and provides tension thereon. Mangle rollers 60 are operated to provide a desired amount of tension in the gelatin sheets 21 throughout the encapsulation machine 20.

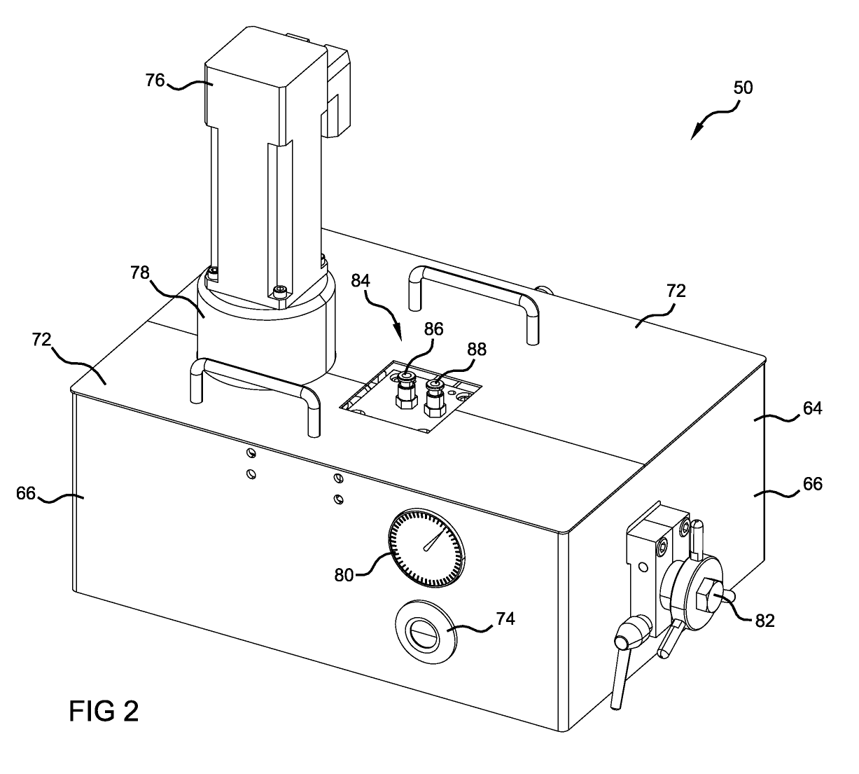

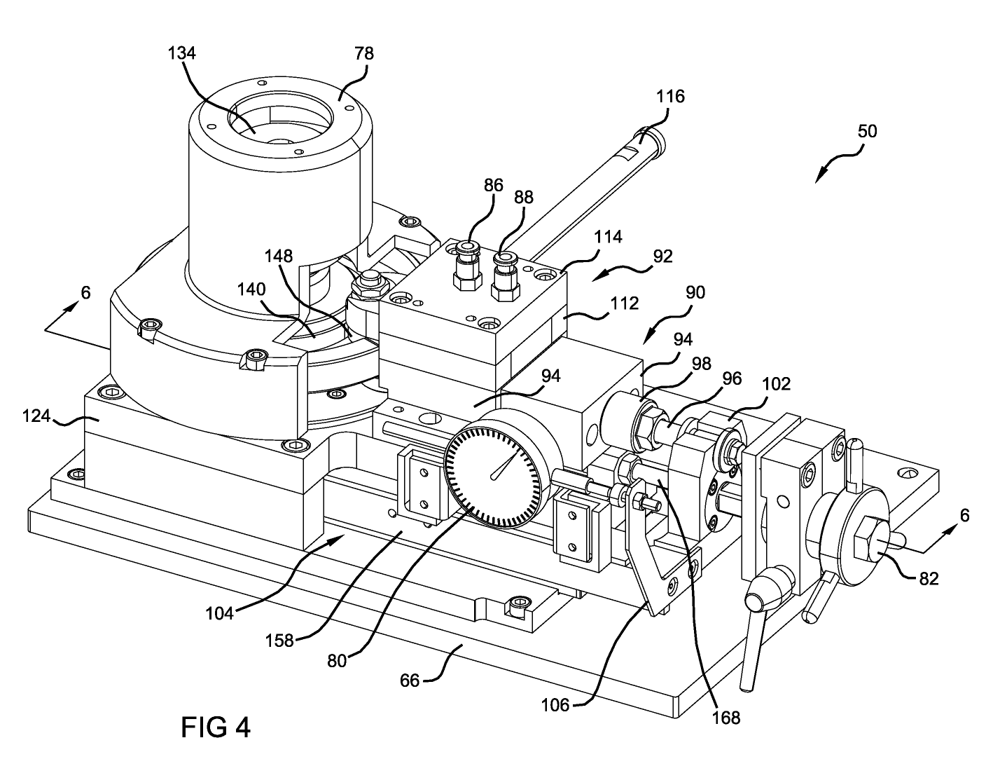

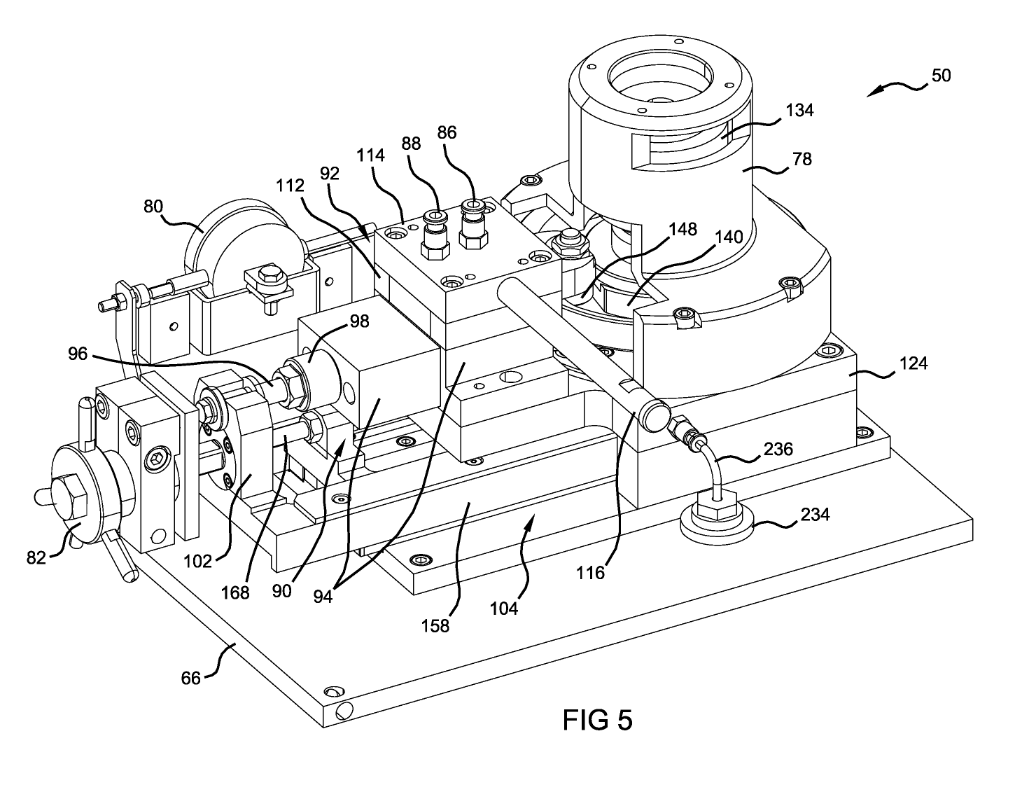

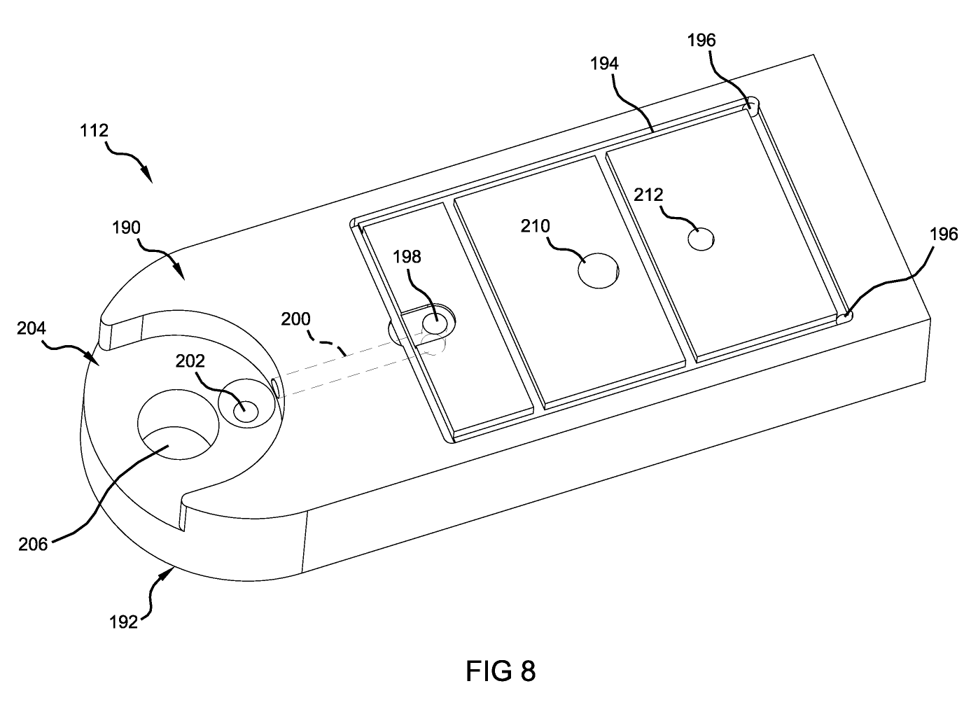

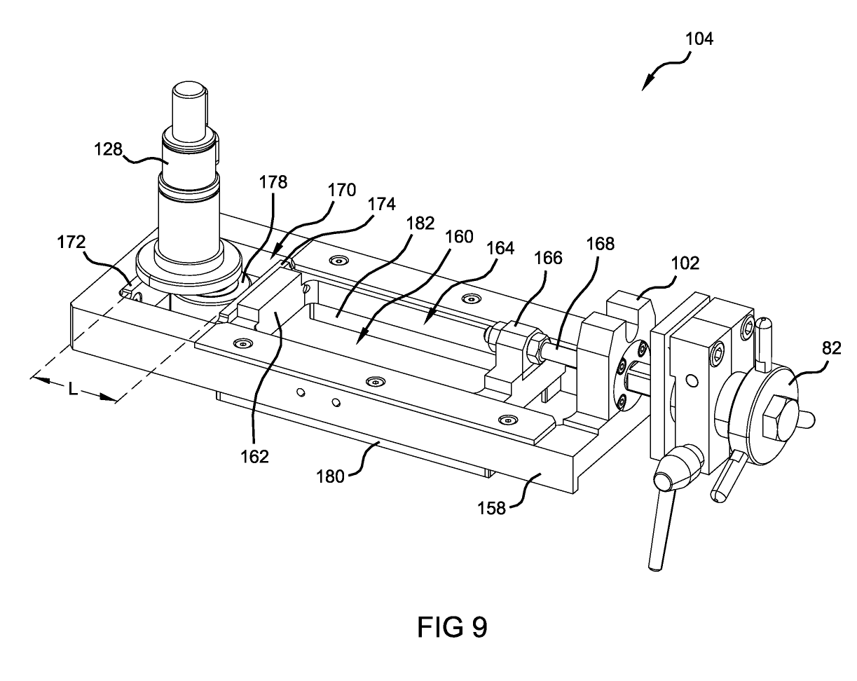

Referring now to FIGS. 2-9, details of fill supply mechanism 50 according to the present disclosure are shown. Fill supply mechanism 50 includes a housing 64, which includes a base 66 and a plurality of upstanding walls 68. Base 66 and walls 68 define an interior cavity 70 that can hold a fluid therein. Lid plates 72 can be disposed on top of walls 68 to provide a top cover for fill supply mechanism 50. A sight gage 74 is provided in one of the walls 68 to allow visual determination of the lubricant level within fill supply mechanism 50. A drive motor 76 can be supported on a motor support housing 78. Motor support housing 78 can extend upwardly beyond lid plates 72 such that drive motor 76 resides above lid plates 72. Drive motor 76 can be a servomotor, as shown, which can provide precise control of the operation of fill supply mechanism 50, as described below. Alternatively, the drive motor can be a variable speed motor or other type of motor, by way of non-limiting example.

A position indicator gage 80 can also be located in one of the walls 68. Position indicator gage 80 can provide a visual indication of the movement (stroke length) of the pump within fill supply mechanism 50.

A stroke adjustment knob 82 can extend out of one of the walls 68 to allow the stroke of the pump of fill supply mechanism 50 to be adjusted from the exterior, as described below. Lid plates 72 can include openings 84 therein that allow access to the inlet 86 and outlet 88 of fill supply mechanism 50.

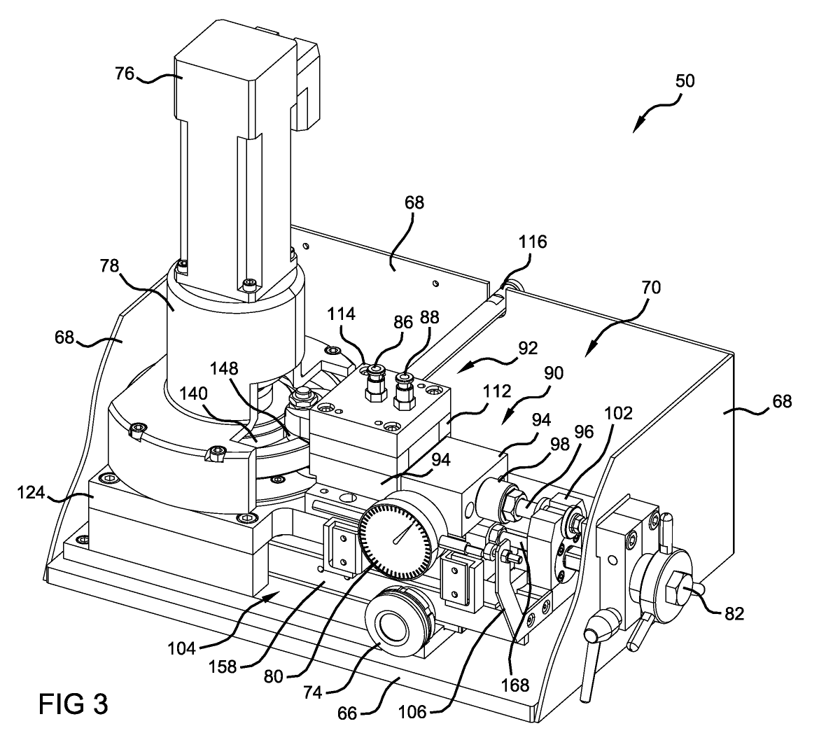

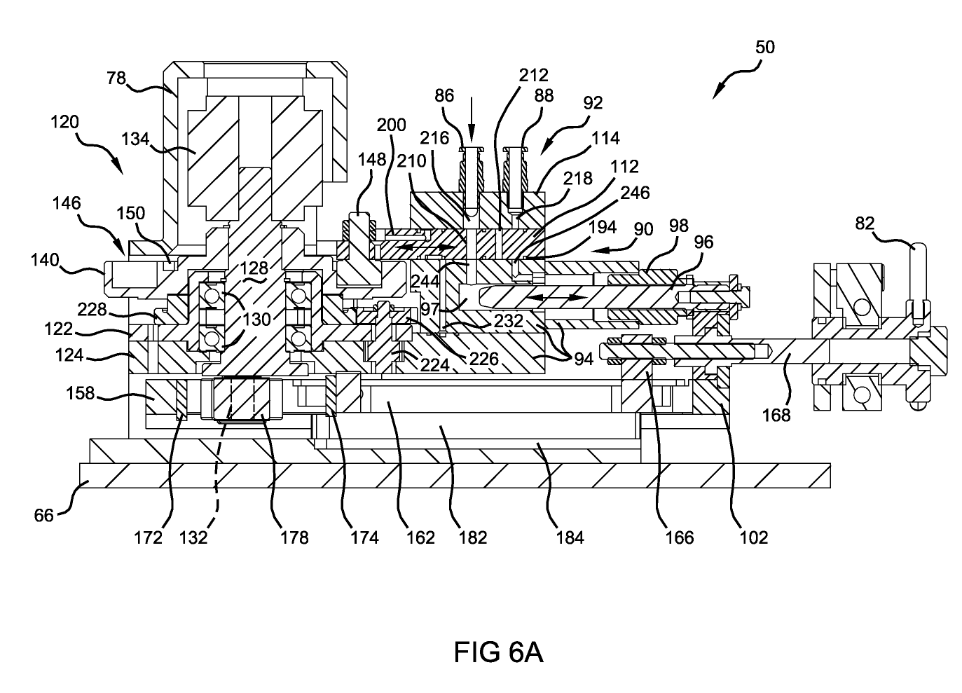

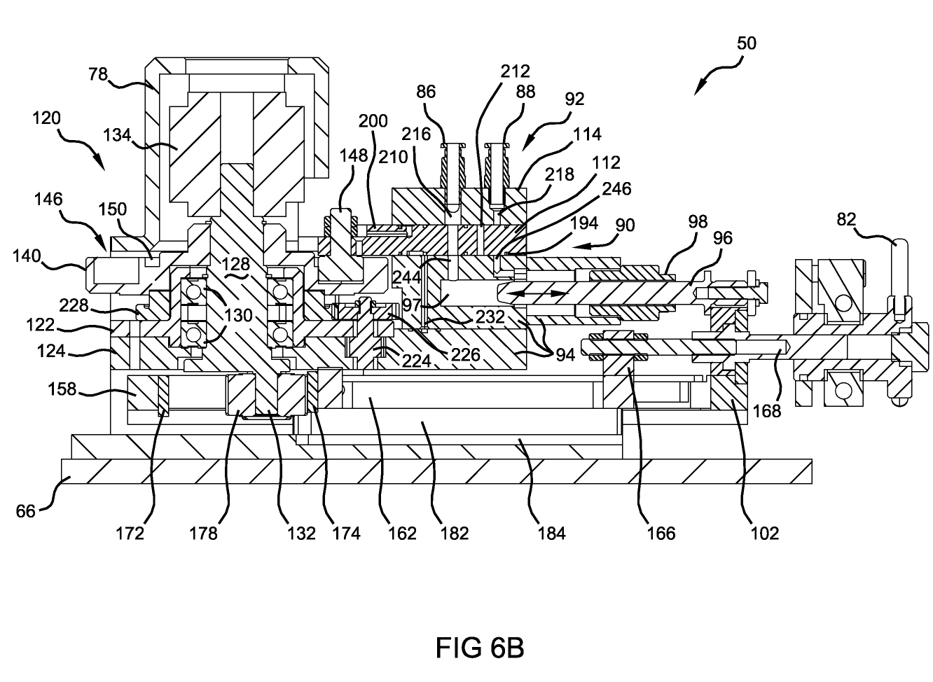

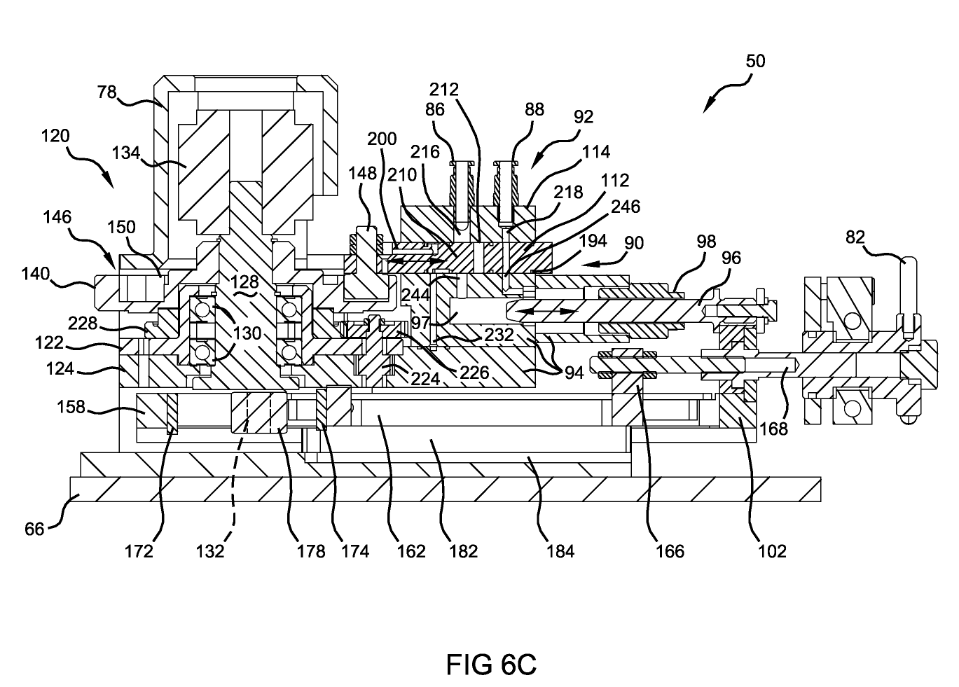

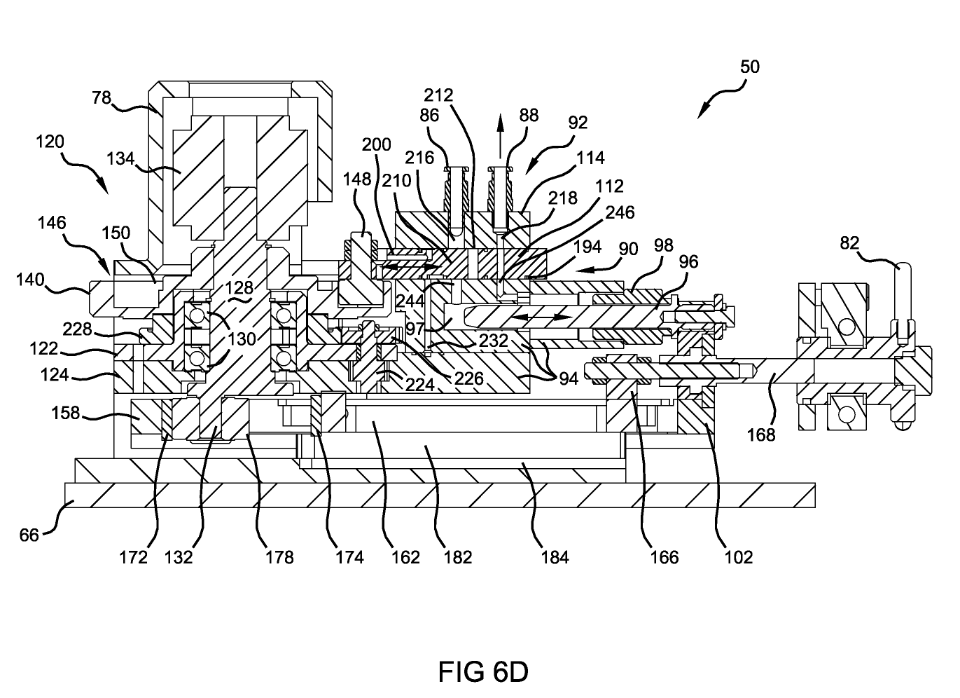

Referring now to FIGS. 3-6D, fill supply mechanism 50 includes a pump 90 and a valve 92 that are driven by rotation of drive motor 76, as described below. Pump 90 includes a multi-piece pump housing 94 and a pumping member 96 that moves relative thereto. Pumping member 96 reciprocates within a pump cavity 97 (shown in FIGS. 6A-D) within pump housing 94. The movement of pumping member 96 within pump cavity 97 draws fill material into pump cavity 97 and pushes the fill material out of pump cavity 97, as described below. Pumping member 96 can be cylindrical and can be a plunger or piston type pumping member 96. A seal 98 seals pumping member 96 to pump housing 94 to inhibit leaks therefrom during relative movement. An end of pumping member 96 is secured to a pump member retainer 102 which is part of a pump drive carriage 104, which moves pumping member 96 relative to pump housing 94, as described below. Movement of pump drive carriage 104 is driven by drive motor 76, as described below. Position indicator gage 80 is coupled to a bracket 106 of pump drive carriage 104. This coupling allows position indicator gage 80 to display the relative movement of pump drive carriage 104 and of pumping member 96.

Valve 92 includes a sliding valve member 112 and a stationary valve plate 114. Sliding valve member 112 reciprocates in a motion parallel to the reciprocating motion of pumping member 96, and is driven by rotation of drive motor 76, as described below. Movement of sliding valve member 112 relative to pump housing 94 and valve plate 114 changes the flow communication between inlet 86, outlet 88 and pump cavity 97 to coordinate the drawing of fill material into pump cavity 97 and the pushing of fill material out of pump cavity 97, as described below. A fill material hopper drain line 116 extends from valve plate 114 and communicates with inlet 86. Drain line 116 allows fill material hopper 48 to be drained therefrom without flowing through pump 90. During normal operation, drain line 116 is plugged or otherwise closed so that fill material from fill material hopper 48 entering valve 92 flows to pump 90.

Movement of pump 90 and valve 92 are driven by drive motor 76 through a drive mechanism 120. Drive mechanism 120 includes motor support housing 78, a fixed bearing retainer 122, and a fixed support plate 124. As best seen in FIGS. 6A-D, drive mechanism 120 includes a driveshaft 128 that is rotatably supported within a pair of bearings 130 in bearing retainer 122. One end of driveshaft 128 includes an eccentric pin 132. The other end of driveshaft 128 is disposed within a coupler 134 that is also coupled to the shaft of drive motor 76. Coupler 134 thereby couples drive motor 76 to driveshaft 128. As a result, rotation of drive motor 76 can drive rotation of driveshaft 128 within drive mechanism 120.

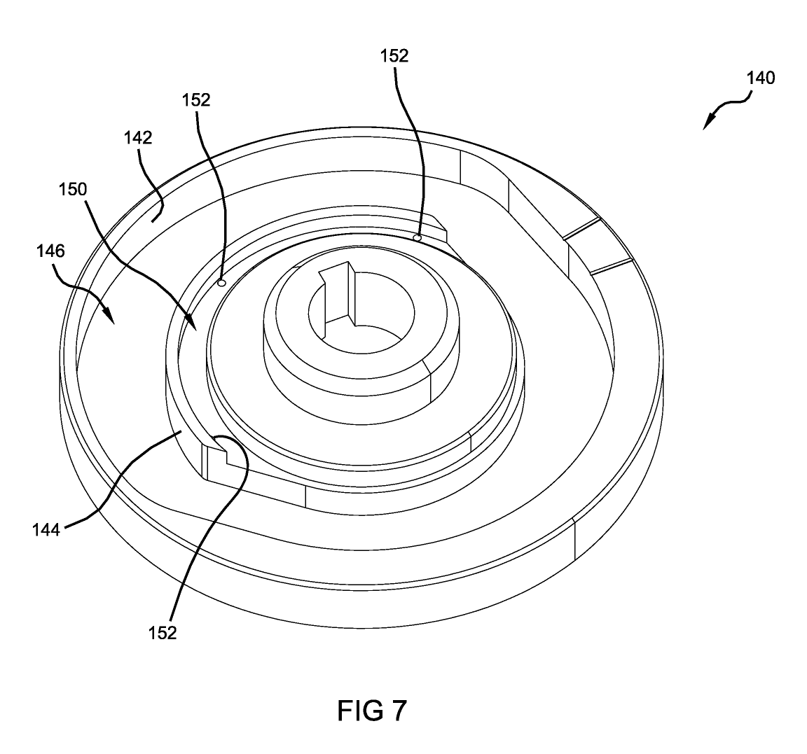

Referring now to FIGS. 6A-D and 7, movement of sliding valve member 112 of valve 92 will be described. Drive mechanism 120 includes a valve cam wheel 140 that is disposed on driveshaft 128. Valve cam wheel 140 and driveshaft 128 are rotationally locked together such that rotation of driveshaft 128 drives rotation of valve cam wheel 140. Valve cam wheel 140 includes an outer cam wall or surface 142, an inner cam wall or surface 144, and a track or channel 146 extending radially therebetween. As best seen in FIG. 7, outer and inner cam walls 142, 144 vary in their radial positions such that track 146 is non-circular. This non-circular track 146 drives reciprocal movement of sliding valve member 112 as valve cam wheel 140 rotates with driveshaft 128. A valve cam follower 148 is attached to sliding valve member 112 and rides within track 146. Rotation of valve cam wheel 140 causes sliding valve member 112 to move between a first position, as shown in FIGS. 6A and B, and a second position, as shown in FIGS. 6C and D. This movement is caused by valve cam follower 148 moving axially relative to driveshaft 128 as track 146 draws valve cam follower 148 toward driveshaft 128 and away from driveshaft 128 during rotation.

Valve cam wheel 140 includes an inner raised track 150 with a plurality of axially extending drain holes 152 therein. Drain holes 152 serve to allow lubricant within valve cam wheel 140 to drain therefrom through drain holes 152, as described below.

Referring now to FIGS. 6A-D and 9, details of pump drive carriage 104 and its interaction with drive mechanism 120 are shown. Pump drive carriage 104 includes an outer carriage member 158 that can be a generally rectangular frame with an interior opening 160. An inner carriage member 162 is disposed within opening 160 of outer carriage member 158. Inner carriage member 162 can also be a generally rectangular frame with an interior opening 164 therethrough. Inner carriage member 162 has a shorter length than the length of opening 160 of outer carriage member 158. This difference in length allows inner carriage member 162 to be moved within opening 160 of outer carriage member 158 to change the stroke of pump 90, as described below. Inner carriage member 162 includes a spacing rod retainer 166 to which a spacing rod 168 is secured. Spacing rod 168 extends into pump member retainer 102 and is coupled to stroke adjustment knob 82. Rotation of stroke adjustment knob 82 moves spacing rod 168 relative to outer carriage member 158 which thereby moves inner carriage member 162 within opening 160 of outer carriage member 158.

The axial length of inner carriage member 162 is less than the axial length of opening 160 in outer carriage member 158. As a result, a drive opening 170 is formed between the end of inner carriage member 162 opposite retainer 166 and the end of opening 160 in outer carriage member 158 opposite pump member retainer 102. Drive opening 170 has an axial length L that can be changed by rotation of stroke adjustment knob 82. Specifically, as stroke adjustment knob 82 is rotated, spacing rod 168 moves inner carriage member 162 within opening 160 of outer carriage member 158, thereby changing the length L of drive opening 170. In this manner, stroke adjustment knob 82 can change the length L of drive opening 170.

Wear plates 172,174 are disposed in drive opening 170 and are attached to outer carriage member 158 and inner carriage member 162, respectively. A carriage cam wheel 178 is attached to eccentric pin 132 of driveshaft 128 and is disposed in drive opening 170. Due to eccentric pin 132 being offset from the rotation axis of driveshaft 128, carriage cam wheel 178 moves in an eccentric fashion within drive opening 170 as driveshaft 128 rotates. This eccentric movement causes carriage cam wheel 178 to engage with wear plates 172, 174 as driveshaft 128 rotates.

Pump drive carriage 104 includes a plurality of guide tracks 180, 182 on the respective outer and inner carriage members 158, 162. Guide tracks 180, 182 engage with complementary tracks 184 on base 66 to guide reciprocating motion of pump drive carriage 104 relative to base 66.

The length L of drive opening 170 determines the axial distance that pump drive carriage 104 can move relative to base 66. With pumping member 96 secured to pump member retainer 102, movement of pump drive carriage 104 relative to base 66 causes pumping member 96 to move relative to pump housing 94 and pump cavity 97. In this manner, the stroke of pumping member 96 can be changed by rotation of stroke adjustment knob 82 which changes the length L of drive opening 170. Because pump 90 is a positive displacement pump, changing the stroke changes the volume of fill material delivered in each stroke of pump 90.

During rotation of driveshaft 128, carriage cam wheel 178 engages with wear plates 172, 174. During certain periods of rotation of driveshaft 128, carriage cam wheel 178 may not be engaged with either wear plate 172, 174. During these periods of rotation, pump drive carriage 104 remains stationary while driveshaft 128 continues to rotate and carriage cam wheel 178 moves within drive opening 170.

Referring now to FIGS. 6A-D and 8, details of sliding valve member 112 are shown. Sliding valve member 112 includes opposite upper and lower surfaces 190, 192 that face and engage with valve plate 114 and pump housing 94, respectively. Both upper and lower surfaces 190, 192 include a lubrication track 194 that extends along the surfaces in a plurality of interconnected rectangular configurations. Through holes 196 are located at two corners of lubrication track 194 and communicate between lubrication tracks 194 on first and second surfaces 190, 192. A drain opening 198 extends from upper surface 190 partially into sliding valve member 112 and directs lubricant captured therein to an internal drain channel 200 that directs the lubricant to another drain opening 202 in a recessed section 204 of sliding valve member 112. Valve cam follower 148 is attached to sliding valve member 112 through opening 206 in recessed section 204. A portion of valve cam follower 148 is disposed beneath drain opening 202 such that lubricant flowing through drain opening 202 flows onto valve cam follower 148 and into track 146 of valve cam wheel 140.

Sliding valve member 112 includes an inlet channel 210 and a discharge channel 212. Inlet and discharge channels 210, 212 extend entirely through sliding valve member 112 and can be aligned with inlet channel 216 and discharge channel 218 in valve plate 114, depending upon the position of sliding valve member 112, as described below.

Referring now to FIGS. 5 and 6A-D, details of the lubrication system for fill supply mechanism 50 are shown. The lubrication system includes a lubricant pump 224 that is disposed within openings in bearing retainer 122 and support plate 124. Lubricant pump 224 has a gear 226 attached thereto that is intermeshed with a gear 228 rotatably disposed on bearing retainer 122. Gear 228 is part of drive mechanism 120 and is rotationally fixed to valve cam wheel 140 such that rotation of driveshaft 128 causes rotation of gear 228 which in turn rotates intermeshed gear 226 which drives rotation of lubricant pump 224.

The discharge of lubricant pump 224 communicates with a lubricant passageway 232 in pump housing 94. Lubricant passage 232 directs the lubricant through pump housing 94 and into lubricant track 194 on lower surface 192 of sliding valve member 112. The lubricant travels along lubricant track 194 on lower surface 190, up through opening 196 and along lubricant track 194 on upper surface 190, through drain channel 200 and onto valve cam follower 148 through drain opening 202. The lubricant on valve cam follower 148 fills track 146 of valve cam wheel 140. As the lubricant level rises, the lubricant will enter inner track 150 and drain through drain holes 152 therein. The oil draining through drain holes 152 drops onto gears 226, 228, thereby lubricating gears 226, 228. Lubricant continues to fall and joins the lubricant in housing 64. Pump drive carriage 104 and its components may be at least partially submerged in the lubricant within housing 64.

As shown in FIG. 5, a strainer/filter 234 is coupled to a lubricant inlet line 236 which communicates with lubricant pump 224. Lubricant within housing 64 is picked up by lubricant pump 224 through strainer/filter 234 and lubricant inlet line 236. Thus, rotation of driveshaft 128 can drive lubricant pump 224 and provide lubrication to the various components of fill supply mechanism 50.

Referring now to FIGS. 6A-D, pump housing 94 includes an inlet channel 244 and a discharge channel 246 that communicate with pump cavity 97 and extend through the top of pump housing 94. Inlet and discharge channels 244, 246 can align with inlet and discharge channels 210, 212 of sliding valve member 112, depending upon the position of sliding valve member 112. Inlet and discharge channels 244, 246 allow pumping member 96 to draw the fill material into pump cavity 97 and discharge the fill material from pump cavity 97.

In fill supply mechanism 50, drive mechanism 120 is operable to move both sliding valve member 112 and pumping member 96 reciprocally to draw fill material from fill material hopper 48 and supply the fill material to wedge assembly 40. The engagement between valve cam wheel 140 and valve cam follower 148 drives the reciprocal motion of sliding valve member 112, while the engagement of carriage cam wheel 178 with pump drive carriage 104 drives reciprocal movement of pumping member 96. Both of these reciprocal motions are driven by rotation of driveshaft 128 which in turn is driven by drive motor 76. Track 146 of valve cam wheel 140 is configured to coordinate the movement of sliding valve member 112 with the movement of pumping member 96 such that the associated inlet channels are aligned when drawing fill material into pump cavity 97 and the associated discharge channels are aligned when pumping the fill material out of pump cavity 97, as described below.

Referring to FIG. 6A, fill supply mechanism 50 is in a position ready to draw fill material from fill material hopper 48. In this position, sliding valve member 112 is in its first position with inlet channel 210 aligned with inlet channel 216 and inlet channel 244. In this position, pump cavity 97 communicates with inlet 86 and pump 90 can draw fill material from fill material hopper 48. Additionally, pumping member 96 is also in its first position, wherein pumping member 96 occupies a majority of pump cavity 97 such that the volume of pump cavity 97 is at a minimum for the particular stroke length of pumping member 96. It should be appreciated that the degree to which the volume of pump cavity 97 is reduced when pumping member 96 is in its first position is a function of the stroke length of pumping member 96. As a result, as the stroke of pumping member 96 is changed, the volume of fill material pumped by pump 90 will also change. Additionally, in this position carriage cam wheel 178 is not actively driving pump drive carriage 104. In some instances, carriage cam wheel 178 may be entirely disengaged from one or both wear plates 172,174.

When it is desired to operate fill supply mechanism 50, drive motor 76 drives rotation of driveshaft 128 which can move eccentric pin 132 and carriage cam wheel 178 to the right, as shown in FIG. 6B. This movement causes carriage cam wheel 178 to engage with wear plate 174 and drive movement of pump drive carriage 104 to the right, in the views depicted in FIGS. 6A-D. This movement causes pumping member 96 to move from its first position to a second position wherein the volume of pump cavity 87 is at a maximum for the particular stroke length of pumping member 96. Again, the degree to which pumping member 96 moves to the right is a function of the stroke of fill supply mechanism 50, as dictated by the length L of drive opening 170. As pumping member 96 moves from the first position to the second position, the fill material is drawn into pump cavity 97 through inlet 86, inlet channels 216, 210, and 244. During this motion, sliding valve member 112 remains stationary.

Continued rotation of driveshaft 128 causes carriage cam wheel 178 to move away from wear plate 174 and toward wear plate 172. During the portion of the rotation of driveshaft 128 that carriage cam wheel 178 is not engaged with either wear plate 174, 172, pump drive carriage 104 and pumping member 96 remain stationary. During this rotation, however, valve cam wheel 140 pushes valve cam follower 148 away from driveshaft 128 (to the right in the views depicted in FIGS. 6A-D) and drives movement of sliding valve member 112 to its second position, as shown in FIG. 6C. In the second position, discharge channel 212 of sliding valve member 112 is aligned with discharge channel 246 of pump housing 94 and discharge channel 218 in valve plate 114. With sliding valve member 112 in its second position, pump 90 can discharge the fill material in pump cavity 97 through outlet 88 and onto wedge assembly 40 for injection into the gelatin films 21 to form capsules 22.

As driveshaft 128 continues to rotate, carriage cam wheel 178 will eventually engage with wear plate 172 and drive motion of pump drive carriage 104 to the left in the views depicted in FIGS. 6A-D. This motion causes pumping member 96 to move from its second position, as shown in FIG. 6C, to its first position, as shown in FIG. 6D (to the left in the views depicted in FIGS. 6A-D). Sliding valve member 112 remains stationary as pumping member 96 moves from its second position to its first position. This movement of pumping member 96 pushes the fill material within pump cavity 97 out of pump housing 94 through discharge channel 246, through discharge channel 212 of sliding valve member 112, through discharge channel 218 of valve plate 114, and out outlet 88.

Continued rotation of driveshaft 128 causes valve cam wheel 140 to pull valve cam follower 148 toward driveshaft 128 (to the left in the views depicted in FIGS. 6A-D) and drives movement of sliding valve member 112 from its second position, as shown in FIG. 6D, back to its first position, as shown in FIG. 6A. During this rotation, carriage cam wheel 178 moves away from wear plate 172 and toward wear plate 174. Pump drive carriage 104 and pumping member 96 remain stationary as sliding valve member 112 moves from its second position to its first position.

Continued rotation of driveshaft 128 starts the process over again wherein sliding valve member 112 remains in its first position while pumping member 96 moves to its second position and pulls fill material into pump cavity 97. This is again followed by sliding valve member 112 moving from its first position to its second position while pumping member 96 remains stationary. Pumping member 96 then moves from its second position to its first position while sliding valve member 112 remains stationary, thereby pumping the fill material out of pump cavity 97. Sliding valve member 112 then moves from its second position to its first position as pumping member 96 remains stationary. In this manner, rotation of driveshaft 128 can drive the reciprocal motion of sliding valve member 112 and pumping member 96 to draw fill material from fill material hopper 48 and supply the fill material to wedge assembly 40.

By adjusting the length L of drive opening 170, the quantity of fill material drawn into and discharged by pump 90 for each stroke can be precisely controlled. Additionally, drive motor 76 can be a servomotor wherein the coordination of the operation of fill supply mechanism 50 with that of the rest of the components of encapsulation machine 20 can be precisely controlled to supply the desired quantity of fill material to wedge assembly 40 at the desired time. This capability facilitates the changing of speeds of encapsulation machine 20 and coordinating the operation of fill supply mechanism 50. Additionally, the fill supply mechanism advantageously utilizes reciprocal motion of both valve 92 and pump 90 that are in the same parallel directions. This configuration can save space and facilitate the mechanical linkages that accomplish such parallel motion.

While the present disclosure has been described with reference to specific embodiments, figures, and configurations, it should be appreciated that other components and arrangements having similar functionality and capability can be employed. For example, while a single pump 90 and valve 92 are shown, it should be appreciated that a plurality of pumps and/or valves can be employed and driven by drive mechanism 120 and moved in generally parallel arrangements. Additionally, it should be appreciated that the fill supply mechanism 50 according to the present disclosure can be utilized with a variety of different encapsulation machines. By way of non-limiting example, one suitable gel encapsulation machine is that disclosed in U.S. Pat. No. 7,247,010, entitled “Servo Control for Capsule-Making Machine,” and assigned to the assignee of the present invention, the disclosure of which is incorporated herein by reference. Also by way of non-limiting example, the fill supply mechanism 50 according to the present disclosure may be applicable to hard encapsulation fill machines that fill hard capsules with a liquid fill material. The hard encapsulation fill machines can be those that utilize hard capsules produced by the capsule-making machines disclosed in U.S. Pat. No. 6,000,928, entitled “Capsule Making Machine Having Improved Pin Bars and Airflow Characteristics” and assigned to the assignee of the present invention, and U.S. Pat. No. 5,945,138, entitled “Heating Elevator for Capsule-Making Machine” and assigned to the assignee of the present invention, both disclosures of which are incorporated herein by reference.

Thus, the present disclosure is not limited to soft capsule-making machines. It is noteworthy that the term “hard” and “soft” capsules are relative terms and that “hard” capsules are harder and more rigid than “soft” capsules, but may have some flexibility. Additionally, while the capsules and sheets have been described with reference to gel and gelatin, other materials and substances can be used to form sheets and capsules and still be within the scope of the present disclosure. Furthermore, the present invention can be used with encapsulation machines that do not include casting drums and a spreader box and instead rely upon preformed ribbons that are supplied to the encapsulation machine. However, it should be appreciated that encapsulation machines according to the present disclosures can be servo-driven or conventionally driven through the use of non-servomotors and mechanical interconnections. Thus, the description of the disclosure is merely exemplary in nature and variations that do not depart from the gist of the disclosure are intended to be within the scope of the disclosure. Such variations are not to be regarded as a departure from the spirit and scope of the disclosure.

What is claimed is:

1. A fill supply mechanism comprising:
a pump including a pump housing, a pump cavity in said housing, and a pumping member disposed in said pump cavity and reciprocally moveable between a first pumping member position and a second pumping member position, movement of said pumping member relative to said pump cavity causing fill material to be drawn into and expelled from said pump cavity;
a valve having a valve member reciprocally movable between a first valve member position and a second valve member position, said valve member allowing fill material to be drawn into said pump cavity when in said first valve member position and allowing fill material to be expelled from said pump cavity when in said second valve member position; and
a drive mechanism coupled to said pumping member and to said valve member, said drive mechanism operable to drive reciprocal motion of said pumping member between said first pumping member position and said second pumping member position and to drive reciprocal motion of said valve member between said first valve member position and said second valve member position,
wherein said reciprocal motion of said pumping member and reciprocal motion of said valve member is along co-planar axes.

2. The fill supply mechanism of claim 1, wherein said reciprocal motion of said pumping member and reciprocal motion of said valve member is along parallel co-planar axes.

3. The fill supply mechanism of claim 1, wherein a distance between said first valve member position and said second valve member position is a fixed distance and a distance between said first pumping member position and said second pumping member position is a variable distance.

4. The fill supply mechanism of claim 3, wherein said drive mechanism includes a moveable pump drive carriage having a drive opening therein within which a pump drive member is disposed and said drive opening having a length that is variable and changes in said length changes said distance between said first pumping member position and said second pumping member position.

5. The fill supply mechanism of claim 4, wherein said pump drive carriage is coupled to said pumping member such that movement of said pump drive carriage drives movement of said pumping member, said pump drive member is a cam member that rotates relative to said drive carriage within said drive opening, and rotation of said cam member driving movement of said pump drive carriage.

6. The fill supply mechanism of claim 1, wherein said drive mechanism includes a first cam member operable to drive reciprocating motion of said valve member and a second cam member operable to drive reciprocating motion of said pumping member.

7. The fill supply mechanism of claim 1, wherein said pump housing has inlet and discharge channels extending through said pump housing and communicating with said pump cavity, said valve member has inlet and discharge channels extending therethrough, and said inlet channels are in fluid communication when said valve member is in said first valve member position while said discharge channels are not in fluid communication and said discharge channels are in fluid communication when said valve member is in said second valve member position while said inlet channels are not in fluid communication.

8. The fill supply mechanism of claim 1, wherein said pumping member remains stationary while said valve member moves between said first and second valve member positions and said valve member remains stationary while said pumping member moves between said first and second pumping member positions.

9. An improved soft gel encapsulation machine of the type having a pair of dies with cavities thereon and operable to form capsules therebetween and a wedge assembly receiving fill material from a fill supply mechanism and operable to insert the fill material into the cavities in the dies such that capsules formed between the dies contain the fill material, wherein the improvement comprises a fill supply mechanism including:
a pumping member disposed in a pump cavity and reciprocally moveable between a first pumping member position and a second pumping member position, movement of said pumping member relative to said pump cavity causing fill material to be drawn into and expelled from said pump cavity;
a valve member reciprocally movable between a first valve member position and a second valve member position, said valve member allowing fill material to be drawn into said pump cavity when in said first valve member position and allowing fill material to be discharged from said pump cavity when in said second valve member position; and
a drive mechanism coupled to said pumping member and to said valve member, said drive mechanism operable to drive reciprocal motion of said pumping member between said first and second pumping member positions and to drive reciprocal motion of said valve member between said first and second valve member positions, said reciprocal motion of said pumping member and reciprocal motion of said valve member being along co-planar axes.

10. The encapsulation machine of claim 9, wherein said reciprocal motion of said pumping member and reciprocal motion of said valve member is along parallel co-planar axes.

11. The encapsulation machine of claim 9, wherein a distance between said first valve member position and said second valve member position is a fixed distance, a distance between said first pumping member position and said second pumping member position is a variable distance, and changes is said distance between said first and second pumping member positions is changes said quantity of fill material supplied.

12. The encapsulation machine of claim 9, wherein said drive mechanism includes a first cam member operable to drive reciprocating motion of said valve member and a second cam member operable to drive reciprocating motion of said pumping member.

13. An improved encapsulation machine of the type operable to produce soft capsules with a fill material therein, wherein the improvement comprises:
a pump operably causing fill material to be drawn into and expelled from a pump cavity;
a valve operably allowing fill material to be drawn into and discharged from said pump cavity; and
an actuator operably moving said pump and said valve, operable movement of said pump and said valve being along substantially co-planar axes.

14. The encapsulation machine of claim 13, wherein the operable movement of said pump and said valve are along substantially parallel co-planar axis.

15. The encapsulation machine of claim 13, wherein said actuator includes a single rotatably driven shaft.

16. The encapsulation machine of claim 15, wherein said actuator includes first and second cam members coupled to said shaft and operably moving said valve and said pump, respectively.

17. An improved encapsulation machine of the type operable to produce soft capsules with a fill material therein, wherein the improvement comprises:
a pump including a pump housing, a pump cavity in said housing, inlet and discharge channels in said housing communicating with said pump cavity, and a pumping member disposed in said pump cavity and reciprocally moveable between a first pumping member position and a second pumping member position, movement of said pumping member relative to said pump cavity causing fill material to be drawn into said pump cavity through said inlet channel and expelled from said pump cavity through said discharge channel;
a valve having a valve member reciprocally movable between a first valve member position and a second valve member position, said valve member having inlet and discharge channels extending therethrough, said valve member inlet channel being aligned with said pump housing inlet channel and allowing fill material to be drawn into said pump cavity through said inlet channels when in said first valve member position, and said valve member discharge channel being aligned with said pump housing discharge channel and allowing fill material to be expelled from said pump cavity through said discharge channels when in said second valve member position; and
a drive mechanism including a rotatable driveshaft, first and second cam members coupled to and rotating with rotation of said driveshaft, and a moveable pump drive carriage coupled to said pumping member such that movement of said pump drive carriage drives movement of said pumping member, said pump drive carriage having a drive opening therein within which said second cam member is disposed, rotation of said driveshaft drives reciprocal motion of said valve member between said first and second valve member positions through said first cam member and drives reciprocal motion of said pumping member between said first and second pumping member positions through said second cam member and said pump drive carriage, said drive opening having a length that is variable and changes in said length changes a distance between said first pumping member position and said second pumping member position.

18. The encapsulation machine of claim 17, further comprising a cam follower coupled to said valve member and wherein said first cam member is a cam wheel that rotates with rotation of said driveshaft, said cam wheel having a track within which said cam follower rides, and said valve member moves between said first and second valve member positions as said cam follower moves along said track and said cam wheel rotates.

19. The encapsulation machine of claim 17, wherein said driveshaft includes an eccentric end member and said second cam member is coupled to said eccentric end member such that said second cam member undergoes eccentric motion with rotation of said driveshaft.

20. The encapsulation machine of claim 17, wherein said reciprocal motion of said pumping member and reciprocal motion of said valve member is along substantially parallel co-planar axes.

21. A method of forming soft-gel capsules comprising:
pumping a fill material to a wedge assembly by driving reciprocal motion of a pumping member between first and second pumping member positions and driving reciprocal motion of a valve member between said first and second valve member positions, said reciprocal motion of said pumping member and reciprocal motion of said valve member being along co-planar axes;
supplying two sheets of capsule forming material to said wedge assembly;
heating said sheets and inserting the fill material between said sheets with the wedge assembly; and
forming capsules containing the fill material with a pair of co-acting dies having cavities formed thereon.

22. The method of claim 21, wherein pumping the fill material includes driving reciprocal motion of said pumping member and said valve member along parallel co-planar axes.

23. The method of claim 21, wherein pumping the fill material includes changing a quantity of fill material supplied by changing a distance between said first and second pumping member positions while maintaining a distance between said first and second valve member positions fixed.

24. The method of claim 21, further comprising maintaining said valve member stationary as said pumping member moves between said first and second pumping member positions and maintaining said pumping member stationary as said valve member moves between said first and second valve member positions.
